(19) United States
(12) Patent Application Publication
(10) Pub. No.: US 2006/0059775 A1
(43) Pub. Date: Mar. 23, 2006

(54) Bag for transporting potted plants

(76) Inventor: Garry Thomas L'Estrange, Queensland (AU)

Correspondence Address: ABELMAN, FRAYNE & SCHWAB, 666 THIRD AVENUE, 10TH FLOOR, NEW YORK, NY, 10017, US

(21) Appl. No.: 11/264,431

(22) Filed: Oct. 31, 2005

Related U.S. Application Data
(63) Continuation of application No. 11/218,204, filed on Aug. 31, 2005.

(30) Foreign Application Priority Data
Sep. 2, 2004 (AU) 2004904997

(51) Int. Cl. A01G 9/02

(52) U.S. Cl. 47/65.8

(57) ABSTRACT

A bag for transporting potted plants, including: a base portion sized to accommodate the base of a potted plant; a sidewall portion attached to and extending from the periphery of the base portion a distance sufficient to accommodate the height of a pot of a potted plant; a closure portion extending from the sidewall portion remote from its attachment to the base portion the closure portion to a distal edge, the closure portion having: a draw-string in operative disposition within and extending from a drawstring pocket formed in a hem along the distal edge and being for closing the closure portion about the base or stem of a plant or plants which may be potted in a pot; an opening extending from its junction with the side wall portion; and wherein the closure portion is formed from a material of more flexible nature than the material from which the side wall portion is formed and the base portion is formed from a material of a more rigid nature than the material from which the side wall portion is formed.

### FIELD OF INVENTION

THIS INVENTION relates to a bag for transporting potted plants. The invention is primarily directed to a bag into which potted plants may be placed for transport by vehicle. However, the invention is not limited to this field of use.

### BACKGROUND ART

The transportation of potted plants, particularly from their place of purchase to their intended location, can subject the potted plants to overturning, whereby spillage of soil can occur. Not only does such spillage create a mess, but also can compromise the well-being of the plant.

If potted plants are transported in the open, they may also be subjected to high speed air streams which may remove soil and/or cause windburn or wind damage to the plant, even if the potted plant does not end up being overturned.

U.S. Pat. No. 3,052,063 to Rose-Marie Dunn discloses a plant watering device in the form of a double-bag arrangement. A water-proof inner bag is encased by a fabric “casing” in the form of a bag outside and encasing the water-proof bag. The casing is formed from a fabric having an inner absorbent ply and an outer ply adjacent thereto. Both the water-proof bag and the casing have drawstrings to tighten around the stem or stems of one or more potted plants in a plant pot. The watering device is somewhat complicated, necessitated by the watering function of the device. Users may encounter some difficulty in placement and replacement of potted plants in such a device, and/or may wear easily in the vicinity of the base of the pot contained therein.

The present invention aims to provide a bag for transport of potted plants which alleviates one or more of the disadvantages of the prior art. Other aims and advantages of the invention may become apparent from the following description.

### DISCLOSURE OF THE INVENTION

With the foregoing in view, this invention resides broadly in a bag for transporting potted plants, including:
a base portion sized to accommodate the base of a potted plant;
a sidewall portion attached to and extending from the periphery of the base portion a distance sufficient to accommodate the height of a pot of a potted plant;
a closure portion extending from the sidewall portion remote from its attachment to the base portion and having a closure tie for closing the closure portion about the base or stem of a plant or plants which may be potted in pot.

Preferably, base portion is circular whereby the sidewall portion is attached to the circumferential periphery of the base portion. In such form, it is preferred that the sidewall portion be formed from a pattern substantially rectilinear, the sidewall portion when formed being curved to the curvature of the base portion circumference, whereby the base and sidewall portions together can be formed to cylindrical form of circular section. It will be appreciated that pot for pot plants are predominantly inverted right frusto-conical in form. Accordingly, it is preferred that the dimensions of the base and sidewall portions be selected to accommodate the larger dimension of the pot, and the height of the side wall portion be dimensioned to accommodate the height of the pot. An alternative form of bag according to the invention includes the sidewall portion being formed from a sectorial annular pattern, the sidewall portion when formed being curved to the curvature of the base portion circumference to form an inverted right frusto-conical form to conform substantially with the form of a typical pot for potted plants.

Preferably, the closure portion is formed from a material of more flexible nature than the material from which the side wall portion is formed. It is also preferred that the base portion be formed from a material if a more rigid nature than the material from which the side wall portion is formed.

It is also preferred that the closure portion further includes an opening portion extending from its junction with the side wall portion. In such form, it is preferred that the closure portion be formed in rectilinear form in similar fashion to that of the side wall portion, attached to the periphery of the side wall portion opposed to that which is joined to the base portion. The opening portion thus may be constituted by the two remaining opposed edges of the rectilinear form. The opening portion preferably includes a velour-crochet fastener enabling the opening to be closed by operative attachment of the velour side of the fastener to the crochet side of the fastener.

Preferably, the closure portion includes a draw-string in operative disposition within and extending from a drawstring pocket formed in a hem along the edge of the closure portion remote from its edge attached to the sidewall portion. In a preferred form, the dimensions of the bag are selected to correspond to the dimensions of a standard pot for potted plants. Of course, the bag of the present invention in such form may be provided in a range of sizes selected to correspond to a selected range of standard pot sizes. Moreover, markings and/or indicia may be provided on the sidewall portion for trade, trade mark and/or advertising purposes.

### BRIEF DESCRIPTION OF THE DRAWINGS

In order that the invention may be more readily understood and put into practical effect, reference will now be made to the accompanying drawings which illustrate preferred embodiments of the invention and wherein:—

FIG. 1 is a pictorial view of a bag for transporting potted plants according to the invention;

FIG. 2 is a pictorial view of the bag of FIG. 1 with its opening seam closed;

FIG. 3 is a pictorial view of the bag of FIGS. 1 and 2 shown in a closed attitude about a stem of a potted plant; and

FIG. 4 is a diagrammatic transparent side view of the bag of FIGS. 1 to 3 and including the potted plant contained therein.

### DETAILED DESCRIPTION OF THE DRAWINGS

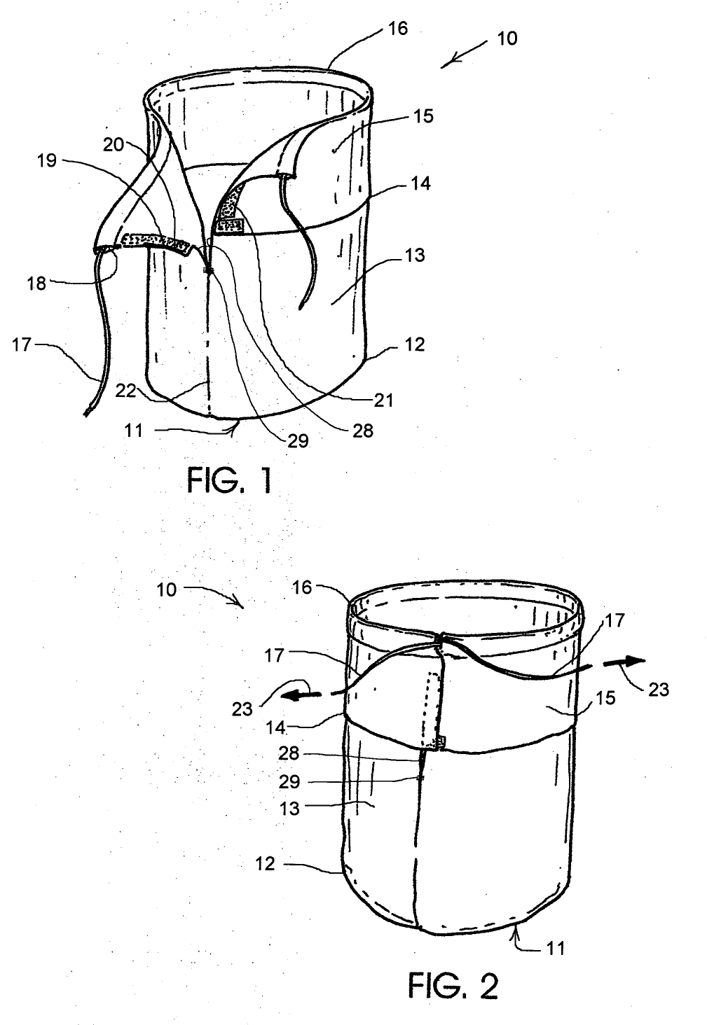

The bag 10 shown in FIGS. 1 and 2 includes a base wall 11 having a side wall 13 extending therefrom, being attached to the base wall along a base seam 12. The side wall extends upward from the base wall, and is attached at its upper edge to a top wall 15 about a girth seam 14 to provide an open top container. The top wall ends at a top edge 16 along which a hem is provided to form a pocket 18 through which a draw string 17 is threaded with its end portions extending from the ends of the pocket and exposed as shown. The top wall also has an opening seam 19, extending to and aligned with a coaxial seam 22 extending across the side wall from the girth seam to the base seam.

The opening seam forms a placket 28 provided with a hooked fastener 20 part way along one side of the opening seam and a corresponding looped fastener 21 on the other side of the opening seam, of course, the hook-and-loop fasteners being provided on opposite faces of the top wall. The placket extends from the top edge to a small way past the girth seam and along the coaxial seam, terminating in a stitched reinforcement 29.

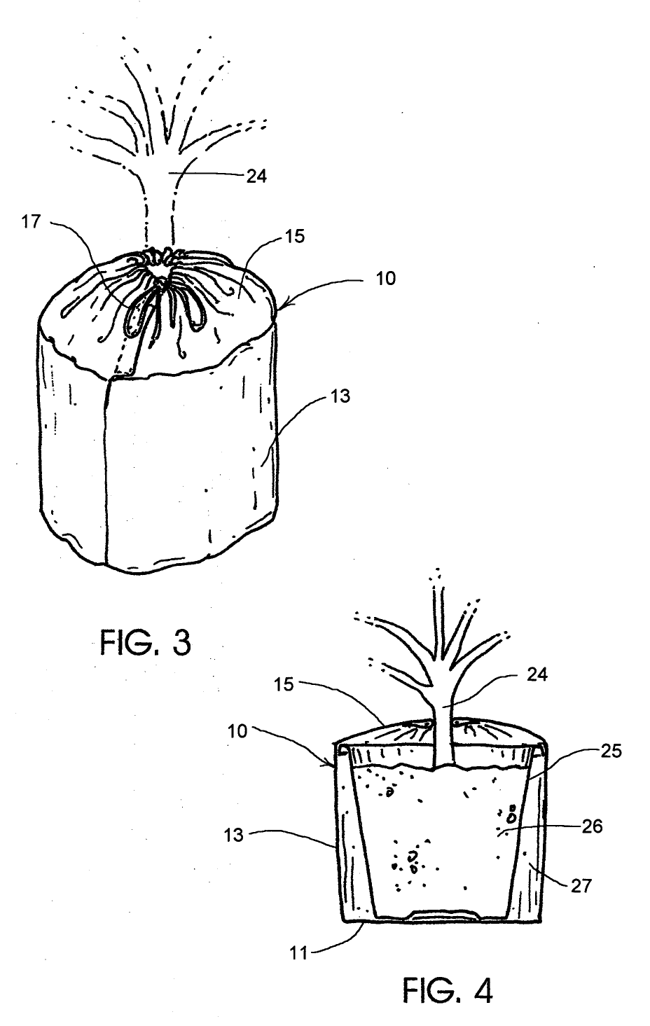

The opening seam can be closed as shown in FIG. 2, and the top edge of the top wall can be reduced in length by pulling the draw string tight in the direction of arrows 23. Upon drawing the draw string tight, the top edge can be gathered as shown in FIG. 3 about the stem of a plant 24, and the draw string may be tied into a bow or the like.

When a potted plant is inserted in the open container of the bag as shown in FIG. 4, and the draw string tightened about the stem, the potted plant may be transported and any concern about spillage of soil 26 from the pot 25 allayed by virtue of the advantages of usage of the present invention. If any soil is displaced from its intended position in the pot, it would either fall back into the pot, the relatively close relationship between the bag and the top rim of the pot substantially preventing the soil from escaping the space between the top of the pot and the bag, or alternatively, even if not retained in such space, be retained in the space 27 between the outside if the pot and the bag.

The bag of the present invention may be transported folded relatively flat due to the flexible nature of at least the side and top portions of the bag. Potted plants may be purchased and inserted one per bag, and the draw strings tied about the stems of the plants in the pots. Of course, where relatively short plants are potted, the draw string may be drawn tight over the top of the plant such that it is entirely retained within the bag. The bag may be provided in a range of colours, for example, for different sizes or adapted for different types of plants. Indeed, any desired markings and/or indicia may provided on the bag for any suitable purpose, particularly in respect of the sidewall of the bag, the top wall being generally unsuitable due to the distortion of any markings thereon with the gathering of the material when the drawstring is tightened.

In the boot of a car or tray of a truck or utility, the potted plants may possibly fall over due to the motion of the vehicle. However, soil or potting mix may be retained within the bag and when the potted plant is removed from the bag, the soil may be tipped from the open bag back into the pot from which it came. In the case of particularly tall plants, or even for shorter plants in or on the tray of a truck, the use of a bag in accordance with the present invention permits that the potted plant may be laid down on its side intentionally for transport. If any soil dislodges from the pot, it would be retained in the bag, and can be returned to the pot after the plant is righted and removed from the bag.

It will be appreciated that in a work of this nature, where perfection that might be attained is placed at so great a distance, it is practical for the inventor to limit his ambitions to that measure of merit which this specification in its present form provides as a disclosure enabling the working of the invention in order to achieve at least one of its advantages. Although the invention has been described with reference to specific examples, it will be appreciated by persons skilled in the art that the invention may be embodied in other forms which are encompassed within the broad scope and ambit of the invention as defined by the following claims.

1. A bag for transporting potted plants, including:
a base portion sized to accommodate the base of a potted plant;
a sidewall portion attached to and extending from the periphery of the base portion a distance sufficient to accommodate the height of a pot of a potted plant;
a closure portion extending from the sidewall portion remote from its attachment to the base portion the closure portion to a distal edge, the closure portion having:
a draw-string in operative disposition within and extending from a drawstring pocket formed in a hem along the distal edge and being for closing the closure portion about the base or stem of a plant or plants which may be potted in a pot;
an opening extending from its junction with the side wall portion;
and wherein the closure portion is formed from a material of more flexible nature than the material from which the side wall portion is formed and the base portion is formed from a material of a more rigid nature than the material from which the side wall portion is formed.

2. A bag according to claim 1, wherein the base portion is circular whereby the sidewall portion is attached to the circumferential periphery of the base portion, the sidewall portion being formed from a substantially rectilinear pattern, the sidewall portion when formed being curved to the curvature of the base portion circumference, whereby the base and sidewall portions together can be formed to cylindrical form of circular section, the dimensions of the base and sidewall portions being selected to accommodate the larger dimension of a typical pot for potted plants, and the height of the side wall portion be dimensioned to accommodate the height of the pot.

3. A bag according to claim 1, wherein the base portion is circular whereby the sidewall portion is attached to the circumferential periphery of the base portion, the sidewall portion being formed from a sectorial annular pattern, the sidewall portion when formed being curved to the curvature of the base portion circumference to form an inverted right frusto-conical form to conform substantially with the form of a typical pot for potted plants.
